(19) United States
(12) Patent Application Publication
(10) Pub. No.: US 2022/0378043 A1
(43) Pub. Date: Dec. 1, 2022

(54) BIOFILM TREATMENT AGENT AND BIOFILM TREATMENT METHOD

(71) Applicant: SEIKO PMC CORPORATION, Tokyo (JP)

(72) Inventors: Takeshi KUBO, Chiba (JP); Ryoji IGARASHI, Chiba (JP)

(73) Assignee: SEIKO PMC CORPORATION, Tokyo (JP)

(21) Appl. No.: 17/623,871

(22) PCT Filed: May 22, 2020
(86) PCT No.: PCT/JP2020/020325

§ 371 Date: Dec. 29, 2021

(30) Foreign Application Priority Data
Jul. 8, 2019 (JP) 2019-126865

(51) Int. Cl. A01N 37/44; A01N 25/30; A01N 31/04; A01N 31/14; A01P 1/00

(52) U.S. Cl. CPC A01N 37/44; A01N 25/30; A01N 31/04; A01N 31/14; A01P 1/00

(57) ABSTRACT

[Problem] A treatment agent having an excellent ability to remove biofilms and a biofilm treatment method in which the treatment agent is used are provided.

[Solution] A biofilm treatment agent characterized by containing at least A1 and/or A2 below. A1: An aromatic monohydric alcohol. A2: An anthranilic acid analog and a biosurfactant. Preferably, the biofilm treatment agent is characterized by containing at least an aromatic monohydric alcohol, an anthranilic acid analog, a biosurfactant, and a synthetic surfactant.

### TECHNICAL FIELD

The present invention relates to a biofilm treatment agent containing at least any one of an aromatic monohydric alcohol, an anthranilic acid analog, and a biosurfactant, and a biofilm treatment method.

### BACKGROUND ART

A biofilm is also called a pellicle and refers to a structure formed by bacteria.

Formation of a biofilm is performed as follows. First, bacteria attached to a substrate secrete extracellular polysaccharides or proteins. These play a role as a barrier or a transport route and protect internal bacteria from environmental changes or chemical substances. It is thought that bacteria gradually form a biofilm on the surface of a substrate while repeating attachment and detachment with respect to the substrate.

Formation of biofilms in heat exchangers, processes of producing various products, or the like is not desirable because it causes deterioration in productivity or quality of products and is likely to cause health damage in some cases. In the related art, bactericides or synthetic surfactants have been used to remove biofilms.

It is necessary for bactericides to be used at a high concentration to be brought into contact with bacteria present in biofilms. High concentrations of bactericides can have harmful effects on the human body and can cause deterioration and corrosion of parts such as the desalination membrane that is the target of biofilm control. In addition, there is a risk that long-term use of bactericides will selectively leave biofilm-forming bacteria resistant to the bactericides in systems. In addition, bacteria killed by a bactericide may be nonspecifically adsorbed onto the surface of a substrate and become a frame for a new biofilm.

Synthetic surfactants are mainly used for removing bacteria or biofilms through a physical action of washing, but their effects on the removal of biofilms when used alone are limited. In addition, since some of them are effective at a high pH, there is a concern about a decrease in safety.

Accordingly, it cannot be stated that the removal of biofilms using bactericides or the removal of biofilms using only synthetic surfactants is always effective. In order to effectively remove biofilms, a physiological approach that acts on live bacteria and decomposes biofilms without killing the bacteria is considered to be effective.

The following are known as techniques for controlling biofilms in the related art.

Patent Literature 1 discloses inhibition of formation of a biofilm using a combination of two types selected from a plurality of surfactants as active components. In addition, Patent Literature 2 discloses decomposition of a biofilm using a combination of a vitamin, a metal ion, a synthetic surfactant, and an antimicrobial active substance (such as an aromatic alcohol) (the biofilm decomposition effect in Patent Literature 2 is obtained from at least a combination of a vitamin, a metal ion, and a synthetic surfactant, and there is no disclosure suggesting or clearly indicating a biofilm decomposition effect of the antimicrobial active substance itself such as an aromatic alcohol).

However, none of the above-described techniques yet have the desired ability to remove biofilms.

### CITATION LIST

### Patent Literature

Patent Literature 1: Japanese Patent Laid-Open No. 2008-120783

Patent Literature 2: Published Japanese Translation No. 2012-512199

### SUMMARY OF INVENTION

### Technical Problem

An objective of the present invention is to provide a treatment agent having an excellent ability to remove biofilms and a biofilm treatment method in which the treatment agent is used.

### Solution to Problem

The present inventors have conducted extensive studies on various kinds of chemical substances and the, possibility of removing and inhibiting formation of biofilms in order to solve the problems. As a result, they have found that a composition containing at least an aromatic monohydric alcohol or containing at least an anthranilic acid analog and a biosurfactant has an excellent biofilm-removing effect, thus leading to realization of the present invention.

That is, the present invention relates to the following.

<1>A biofilm treatment agent containing at least A1 and/or A2 below.
A1: An Aromatic Monohydric Alcohol
A2: An Anthranilic Acid Analog and a Biosurfactant

<2>A biofilm treatment agent containing at least an aromatic monohydric alcohol, an anthranilic acid analog, a biosurfactant, and a synthetic surfactant.

<3>The biofilm treatment agent according to <1> or <2>, in which the aromatic monohydric alcohol is a compound represented by Formula (1) or (2) below or cinnamyl alcohol.

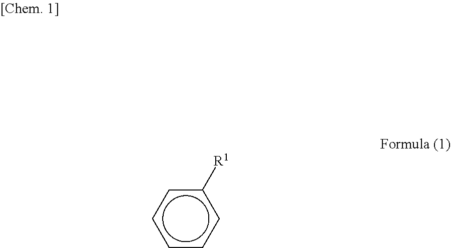

R¹: A Linear Alkyl Group Having 1 to 3 Carbon Atoms in Which one Arbitrary Hydrogen Atom is Substituted With a Hydroxyl Group

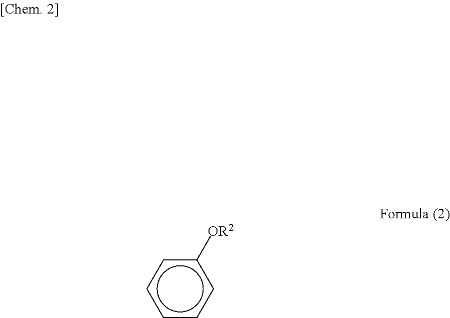

R²: A Linear Alkyl Group Having 1 to 3 Carbon Atoms in Which one Arbitrary Hydrogen Atom is Substituted With a Hydroxyl Group

<4>The biofilm treatment agent according to <1> or <2>, in which the anthranilic acid analog is at least one selected from anthranilic acid, methyl anthranilate, ethyl anthranilate, anthranylamide, and salts thereof.

<5>The biofilm treatment agent according to <1> or <2>, in which the biosurfactant is an amino acid-type orglycolipid-type biosurfactant.

<6>The biofilm treatment agent according to <2>, in which the synthetic surfactant is at least one selected from sodium dodecyl sulfate, sodium dodecylbenzene sulfonate, and polyoxyethylene lauryl ether.

<7>The biofilm treatment agent according to <2>containing an aromatic monohydric alcohol, an anthranilic acid analog, a biosurfactant, and a synthetic surfactant at a mass ratio of 1/0.25 to 2/0.0005 to 2/0.005 to 2.

<8>The biofilm treatment agent according to any one of <1> to <7>, in which a biofilm is formed from bacteria containing at least gram-negative bacteria.

<9>A biofilm treatment method in which the biofilm treatment agent according to <1> or <2>is used, the method including: using the biofilm treatment agent within a concentration range of less than the minimum inhibitory concentration (MIC).

### Advantageous Effects of Invention

According to the present invention, it is possible to obtain a superior biofilm-removing effect to that with the bactericides or synthetic surfactants in the related art using a treatment agent containing an aromatic monohydric alcohol or a combination of an anthranilic acid analog and a biosurfactant as active components. In addition, since such active components are not highly reactive substances such as an oxidizing agent which is one of the bactericides in the related art, they have advantages of being unlikely to cause deterioration of a member or the like on which they are applied and being easy to handle.

### DESCRIPTION OF EMBODIMENTS

Hereinafter, the present invention will be described in detail.

(Biofilm Treatment Agent)

A biofilm treatment agent of the present invention contains at least A1 and/or A2 below.

A1: An Aromatic Monohydric Alcohol

A2: An Anthranilic Acid Analog and a Biosurfactant

In the present invention, the biofilm treatment agent is an agent having at least a biofilm-removing effect. The biofilm treatment agent may have a biofilm-removing effect, and in particular, it more preferably has a biofilm formation-inhibiting effect to be described below because in this case formation of a biofilm is inhibited after a biofilm is removed, whereby a constant environment in which no biofilm is present can be maintained.

Although the biofilm treatment agent of the present invention has the effects of the present invention even with single use of A1 or A2, A1 and A2 are preferably used in combination.

The aromatic monohydric alcohol A1 is not particularly limited but is suitably a compound represented by Formula (1) or (2) below or cinnamyl alcohol from the viewpoint of the biofilm-removing effect. These can be used alone or in combination of two or more thereof.

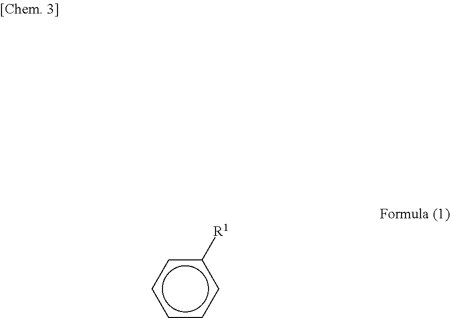

R¹: A Linear Alkyl Group Having 1 to 3 Carbon Atoms in Which one Arbitrary Hydrogen Atom is Substituted With a Hydroxyl Group

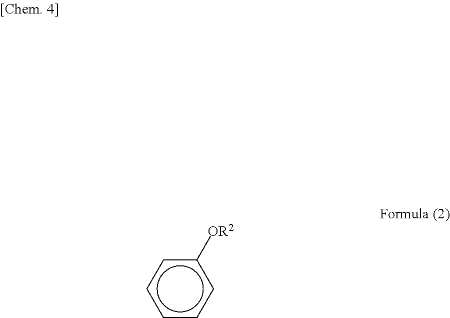

R²: A Linear Alkyl Group Having 1 to 3 Carbon Atoms in Which one Arbitrary Hydrogen Atom is Substituted With a Hydroxyl Group

Specific examples of aromatic monohydric alcohols of Formula (1) include 1-phenylmethanol, 1-phenylethanol, 2-phenylethanol, 1-phenyl-1-propanol, 1-phenyl-2-propanol, and 3-phenyl-1-propanol. In addition, specific examples of Formula (2) include 2-phenoxyethanol, 3-phenoxy-1-propanol, 1-phenoxy-2-propanol, and 3-phenoxy-2-propanol. Among these, 1-phenylmethanol, 1-phenylethanol, 2-phenylethanol, 2-phenoxyethanol, and 3-phenoxy-1-propanol are preferable from the viewpoint of the biofilm-removing effect.

The anthranilic acid analog is anthranilic acid (an anthranilate) and anthranilic acid derivatives. Specific examples of anthranilic acid analogs include anthranilic acid, methyl anthranilate, ethyl anthranilate, propyl anthranilate, butyl anthranilate, 4-chloroanthranilic acid, 6-chloroanthranilic acid, 4-fluoroanthranilic acid, 4-bromoanthranilic acid, 6-bromoanthranilic acid, N-acetylanthranilic acid, N-acetoacetylanthranilic acid, anthranylamide, 4-nitroanthranilic acid, 6-nitroanthranilic acid, and salts thereof. Salts of anthranilic acid analogs are not particularly limited as long as these exhibit the effects of the present invention, but examples thereof include salts neutralized by acids or bases. Examples of acid addition salts include salts of inorganic acids such as hydrochloric acid, sulfuric acid, nitric acid, and phosphoric acid, and salts of organic acids such as acetic acid, malic acid, succinic acid, tartaric acid, and citric acid. Examples of base addition salts include salts of alkali metals such as sodium and potassium, salts of alkaline earth metals such as calcium and magnesium, and salts of amines such as ammonia and triethylamine. Among these, the anthranilic acid analog is preferably at least one selected from anthranilic acid, methyl anthranilate, ethyl anthranilate, anthranylamide, and salts thereof from the viewpoint of the biofilm-removing effect. These can be used alone or in combination of two or more thereof.

The biosurfactant is not particularly limited, but is preferably an amino acid-type or glycolipid-type biosurfactant from the viewpoint of the biofilm-removing effect. Specific examples of amino acid-type biosurfactants include surfactin. In addition, specific examples of glycolipid-type biosurfactants include rhamnolipids and sophorolipids. These can be used alone or in combination of two or more thereof.

The mass ratio of the anthranilic acid analog to the biosurfactant, which are A2 components, is preferably anthranilic acid analog/biosurfactant=1/0.001 to 2 and more preferably 1/0.01 to 2 from the viewpoint of the biofilm-removing effect.

As an example of a more preferred aspect, the, biofilm treatment agent of the present invention further contains a synthetic surfactant in addition to A1 and A2. By combining these, the biofilm-removing effect can be further enhanced.

In the aspect, it is still more preferable that an aromatic monohydric alcohol, an anthranilic acid analog, a biosurfactant, and a synthetic surfactant be contained at a mass ratio of aromatic monohydric alcohol/anthranilic acid analog/biosurfactant/synthetic surfactant=1/0.25 to 2/0.0005 to 2/0.005 to 2.

The synthetic surfactant is preferably anionic or nonionic, and examples of anionic synthetic surfactants include alkyl sulfate ester salts (for example, sodium dodecyl sulfate (SDS) and potassium dodecyl sulfite), alkylbenzene sulfonates (for example, sodium dodecylbenzene sulfonate (LAS) and dodecylbenzene sulfonate triethanolamine), and polyoxyethylene alkyl ether sulfates (for example, sodium polyoxyethylene lauryl ether sulfate (SLS)). in addition, examples of nonionic synthetic surfactants include alcohol ethoxylates (for example, polyoxyethylene lauryl ether (POELE)), glycerin fatty acid esters (for example, glycerin monostearate), and sucrose fatty acid esters (for example, sucrose lauric acid ester). Among these, alkyl sulfate ester salts, alkylbenzene sulfonates, and alcohol ethoxylates are more preferable and sodium dodecyl sulfate, sodium dodecylbenzene sulfonate, and polyoxyethylene lauryl ether are still more preferable from the viewpoint of the biofilm-removing effect. These can be used alone or in combination of two or more thereof.

(Minimum Inhibitory Concentration (MIC))

The biofilm-removing effect or the biofilm formation-inhibiting effect of the biofilm trek agent of the present invention is evaluated at a concentration less than a minimum inhibitory concentration (MIC) by obtaining the MIC of each component of the biofilm treatment agent with respect to biofilm-forming bacteria in advance.

The MIC referred to in the present invention is a minimum concentration (bacteriostatic and antiseptic effects) in which an antibiotic or a bactericide inhibits proliferation of microorganisms. Accordingly, the concentration less than the MIC can be regarded as having the same meaning as a concentration at which a proliferation inhibitory action with respect to biofilm-forming bacteria is not substantially shown.

The method for calculating the MIC in the present invention is as follows.

A compound (hereinafter, sometimes referred to as a substance to be evaluated) that is a component of a biofilm treatment agent is diluted stepwise with a bouillon medium for testing susceptibility to prepare a total amount of 10 mL of dilution series (with the proviso of being 1.1 times the target concentration). 20 μL of a bacterial suspension which has been prepared such that there is 10⁸ cfu/mL of Pseudomonas aeruginosa (deposit number: NBRC106052 strain) which is a representative strain of biofilm-forming bacteria as a test bacterial strain is added thereto and subjected to shaking culture (2000 rpm) with a 96-well microplate mixer at 37° C. for 24 hours. The lowest concentration in the dilution series which is not visually turbid is regarded as the MIC.

The biofilm treatment agent of the present invention allows biofilm-forming bacteria to grow and exhibits the effects of the present invention when the biofilm treatment agent is used such that the concentration of each component contained in the biofilm treatment agent is less than the MC. In other words, the biofilm treatment agent of the present invention does not exhibit the effects of the present invention by sterilizing biofilm-forming bacteria themselves or suppressing proliferation thereof.

In the present invention, the biofilm-removing effect is an action of removing biofilms formed by bacteria. Examples of methods for evaluating an effect of removing substances to be evaluated include a method for comparing the amount of biofilm formed after bringing the substance to be evaluated into contact with a biofilm formed through culturing bacteria for a certain period of time with the amount of biofilm (control) formed after the elapse of a certain period of time without the biofilm being brought into contact with the substance to be evaluated. In this case, when the amount of biofilm formed is smaller than that of the control, it can be determined that the substance to be evaluated has a biofilm-removing effect.

The method for evaluating the biofilm-removing effect in the present invention is as follows.

(i) A triptic soy broth (TBS, Bacto: manufactured by Difco Laboratories) medium having a final concentration of glucose of 1% is used for Pseudomonas aeruginosa (deposit number: NBRC106052 strain) which is a representative strain of biofilm-forming bacteria to prepare a preculture solution under the condition of 120 rpm.

(ii) The preculture solution of which the turbidity (OD) is adjusted to 0.1 is diluted with a TSB medium so that the final concentration is 0.000005% (v/v), and 2 mL of the diluent is dispensed into a 12-well plate. Here, the following OD (turbidity) is a value which is measured with a spectrophotometer (iMark Microplate Reader: manufactured by Bio-Rad Laboratories, Inc.) at a wavelength of 630 nm in which distilled water is used as a blank.

(iii) Culture is performed under the conditions of 37° C. and 130 rpm for 17 hours to form a biofilm.

(iv) The culture solution in each well is removed and each well is rinsed twice with distilled water.

(v) A substance to be evaluated is added to a medium at an appropriate concentration less than the MIC of the target substance, and the pH of the medium is adjusted to 7.0 with hydrochloric acid or sodium hydroxide. 2 mL of a sterile medium (pH=7.0) is added to each well to be used as a negative control.

(vi) Each well is shaken at the same temperature as that of the preculture for 3.5 hours at 130 rpm, the biofilm is brought into contact with the medium containing the substance to be evaluated, and then, the medium in each well is removed, and each well is rinsed twice with distilled water.

(vii) 2 mL of an aqueous crystal violet solution (0.4 w/v %, 20 w/v % methanol) is added to the biofilm adhering in each well, allowed to stand for 2 minutes, and allowed to stain, and then, the stained biofilm is rinsed three times with distilled water, and the aqueous crystal violet solution which has not been bound to the biofilm is removed.

(viii) 2 mL of ethanol is added to each well and allowed to stand for 1 hour to elute crystal violet from the stained biofilm, and the absorbance is measured. Here, the following absorbance is a value which is measured with a spectrophotometer (iMark Microplate Reader: manufactured by Bio-Rad Laboratories, Inc.) at a wavelength of 595 nm in which distilled water is used as a blank.

(ix) Regarding the absorbance of the negative control and each substance to be evaluated, absorbances measured for 4 wells are taken as an average value, and the removal rate of each biofilm is calculated from the following calculation equation.

Biofilm removal rate (%)={1-(absorbance of substance to be evaluated/absorbance of negative control)}×100

(x) The calculated value is evaluated based on the following determination criteria.

### <Determination Criteria>

Removal rate of greater than or equal to 60%: The removal effect is significantly high.

Removal rate of greater than or equal to 40% and less than 60%: The removal effect is high.

Removal rate of greater than or equal to 20% and less than 40%: There is a removal effect.

Removal rate of less than 20%: There is no removal effect, or the removal effect is low.

The practical level of the biofilm-removing effect is greater than or equal to 40%.

In the present invention, the biofilm formation-inhibiting effect is an action of inhibiting formation of biofilms due to bacteria.

The method for evaluating the biofilm formation-inhibiting effect in the present invention is as follows.

(i) A triptic soy broth (TBS, Bacto: manufactured by Difco Laboratories) medium having a final concentration of glucose of 1% is used for Pseudomonas aeruginosa (deposit number; NBRC106052 strain) which is a representative strain of biofilm-forming bacteria to prepare a preculture solution under the condition of 120 rpm.

(ii) The preculture solution of which the turbidity (OD) is adjusted to 0.1 is diluted with a TSB medium so that the final concentration is 0.000005% (v/v). and 2 mL of the diluent is dispensed into a 12-well plate.

(iii) A substance to be evaluated is added to the medium at an appropriate concentration less than the MIC of the target substance, and the pH of the medium is adjusted to 7.0 with hydrochloric acid or sodium hydroxide. One containing no substance to be evaluated is used as a negative control (pH=7.0).

(iv) Culture is performed under the conditions of 37° C. and 130 rpm for 6 hours to form a biofilm.

(v) The culture solution in each well is removed and each well is rinsed twice with distilled water.

(vi) 2 mL of an aqueous crystal violet solution (0.4 w/v %, 20 w/v % methanol) is added to the biofilm adhering in each well, allowed to stand for 2 minutes, and allowed to stain, and then, the stained biofilm is rinsed three times with distilled water, and the aqueous crystal violet solution which has not been bound to the biofilm is removed.

(vii) 2 mL of ethanol is added to each well and allowed to stand for 1 hour to elute crystal violet from the stained biofilm, and the absorbance at a wavelength of 595 nm is measured.

(viii) Regarding the absorbance of the negative control and each substance to be evaluated, absorbances measured for 4 wells are taken as an average value, and the biofilm formation inhibition rate is calculated from the following calculation equation.

Biofilm formation inhibition rate (%)={1-absorbance of substance to be evaluated/absorbance of negative control)}×100

(ix) The calculated value is evaluated based on the following determination criteria.

### <Determination Criteria>

Formation inhibition rate of greater than or equal to 60%: The inhibition effect is significantly high.

Formation inhibition rate of greater than or equal to 40% and less than 60%: The inhibition effect is high.

Formation inhibition rate of greater than or equal to 20% and less than 40%: There is an inhibition effect.

Formation inhibition rate of less than 20%: There is no inhibition effect, or the inhibition effect is low.

The practical level of the biofilm formation-inhibiting effect is greater than or equal to 40%.

Based on the results verified so far, the present inventors believe that an aromatic monohydric alcohol or an anthranilic acid analog in the biofilm treatment agent of the present invention affects quorum sensing of biofilm-forming bacteria to exhibit the biofilm-removing effect or the biofilm formation-inhibiting effect.

The biofilm treatment agent of the present invention may be in the original form or may be in any form of a solution diluted with an arbitrary medium, a dispersion, a gel-like substance, or the like. However, the biofilm treatment agent is usually used in the form of a solution when it is allowed to act on a biofilm. The concentration of a diluted biofilm treatment agent is not particularly limited, but the diluted biofilm treatment agent is required to have a concentration to a degree in which the effects of the present invention are exhibited when it is allowed to act on biofilm-forming bacteria.

A thickener, a viscosity adjuster, a pH adjuster, a solvent, a fragrance, a colorant, an antioxidant, a preservative, a fluorescent agent, an excipient, a soil release agent, a bleaching agent, a bleaching activator, a powdering agent, a granulating agent, a coating agent, and the like can be blended with the biofilm treatment agent of the present invention within a range not impairing the objective of the present invention.

(Use of Biofilm Treatment Agent)

Hereinafter, preferred conditions of use of the biofilm treatment agent of the present invention will be described.

Regarding a use concentration of the biofilm treatment agent, a use concentration of each component contained in the biofilm treatment agent is preferably less than the MIC of main causative bacterial species constituting a biofilm. By using the biofilm treatment agent at a concentration less than the MIC, killing of biofilm-forming bacteria can be suppressed and nonspecific adsorption of killed bacteria on the surface of a substrate can be suppressed, which leads to suppression of the killed bacteria from becoming a frame for a new biofilm. The biofilm treatment agent is preferably a single agent in terms of handling. However, components may be prepared individually and mixed with each other when brought into contact with biofilm-forming bacteria.

The pH of a solution when using the biofilm treatment agent can be appropriately set. However, if the biofilm treatment agent is used in a neutral pH range (7.0 to 8.0), it is safe because it is unnecessary to consider influences on the human body and water environment used.

The time over which the biofilm treatment agent is allowed to act varies depending on the amount of biofilm adhered, the concentration of active components, the operating temperature, and the presence or absence of physical force, but is usually within a range of several minutes to several hours. In addition, by bringing the biofilm treatment agent into contact with a member in which formation of a biofilm is desired to be inhibited in advance for about several minutes to several hours, formation of a biofilm can be inhibited by an action of an aromatic monohydric alcohol or an anthranilic acid analog.

(Biofilm Forming Bacteria)

Biofilm-forming bacteria to which the biofilm treatment agent of the present invention is applied include any gram-negative bacteria forming a biofilm. Among these, the biofilm treatment agent is preferably used for the genera Ochrobactrum, Aeromonas, Klebsiella, Acinetobacter, Enterobacter, Citrobacter, Stenotrophomonas, Pseudomonas, Rhizobium, and Cupriavidus belonging to the phylum Proteobacteria. In most cases, a biofilm is formed by two or more kinds of bacteria, and a biofilm containing one or more kinds of biofilm-forming bacteria is the subject of the present invention.

The biofilm treatment agent of the present invention can be used in a wide range of fields in which a biofilm is formed and becomes a problem. For example, the biofilm treatment agent can be applied to drainage ditches or drainage pipes of food production plants or beverage production plants, kitchenettes, canteens, bathrooms, toilets, kitchens, and the like. In addition, the, biofilm treatment agent can be applied to cooling water systems such as industrial cooling towers and circulating water system paths of water treatment membranes, desalination devices, paper mills, and the like. In addition, the biofilm treatment agent can also be applied to cleansers of medical devices, for example, endoscopes, catheters, and artificial dialyzers, in which biofilms are likely to be formed.

### EXAMPLES

Hereinafter, the present invention will be described in detail based on examples, but is not limited to thereto.

The biofilm-removing effect or the biofilm formation-inhibiting effect of the biofilm treatment agent of the present invention is evaluated at a concentration less than the MIC by obtaining the MIC of each component of the biofilm treatment agent with respect to biofilm-forming bacteria in advance. An MIC test method will be shown below.

<Minimum Inhibitory Concentration (MIC) Test Method>

Pseudomonad (gram-negative bacterium) known as a model bacterium forming a biofilm was used as a test bacterium to MIC's of compounds (hereinafter, substances to be evaluated) that are components of a biofilm treatment agent.

(1) Test Bacterium Pseudomonas aeruginosa (Deposit Number: NBRC106052 Strain)

### (2) Substances to be Evaluated

The compounds shown in Table 1 were used as substances to be evaluated. Among the compounds of Table 1, 1-pentanol, 2-phenyl-1,3-propanediol, 3-phenoxy-1,2-propanediol, and DBNPA (2,2-dibromo-3-nitrilopropionamide) were used as comparative examples in the following test.

### (3) Test Method

Each substance to be evaluated was diluted stepwise with a bouillon medium for testing susceptibility to prepare a total amount of 10 mL of dilution series (with the proviso of being 1.1 times the target concentration). 20 μL of a bacterial suspension which had been prepared such that there was 10⁸ cfu/mL of a test bacterial strain was added thereto and subjected to shaking culture (2000 rpm) with a 96-well microplate mixer at 37° C. for 24 hours. The lowest concentration in the dilution series which was not visually turbid was regarded as the MIC.

### (4) Test Results

The results are shown in Table 1. In the table, being “>numerical value” indicates that the MIC is greater than the numerical value.

The evaluation of the biofilm-removing effect and the evaluation of the biofilm formation-inhibiting effect below were performed on A1 components, A2 components, synthetic surfactants, alcohols other than the A1 components, and DBNPA (2,2-dibromo-3-nitrilopropionamide) which is one kind of organic bactericides at concentrations less than the MIC.

TABLE 1

| Biofilm treatment | | Compounds as substances | MIC |
|---|---|---|---|
| agent components | | to be evaluated | (ppm) |
| A1 | Aromatic | 1-Phenylmethanol | 2,500 |
| | monohydric alcohols | l-Phenylethanol | 5,000 |
| | | 2-Phenylethanol | 5,000 |
| | | Cinnamyl alcohol | 2,500 |
| | | 2-Phenoxyethanol | 2,500 |
| | | 3-Phenoxy-1-propanol | 2,500 |
| A2 | Anthranilic acid | Anthranilic acid | 10,000 |
| | analogs | Anthranylamide | 5,000 |
| | | Methyl anthranilate | 1,250 |
| | Biosurfactants | Rhamnolipid | >10,000 |
| | | Sophorolipid | >10,000 |
| | | Surfactin | 10,000 |

| | | |
|---|---|---|
| Synthetic surfactants | SDS | 2,000 |
| | LAS | 2,000 |
| | POELE | >2,000 |
| Alcohols other than A1 | 1-Pentanol | >5,000 |
| | 2-Phenyl-1,3-propanediol | >5,000 |
| | 3-Phenoxy-1,2-propanediol | >5,000 |
| Organic bactericides | DBNPA | 19.5 |

The abbreviations in the table are as follows.

SDS: sodium dodecyl sulfate (synthetic surfactant)

LAS: sodium dodecylbenzene sulfonate (synthetic surfactant)

POELE: polyoxyethylene lauryl ether (synthetic surfactant; HLB 12.1)

DBNPA: 2,2-dibromo-3-nitrilopropionamide (organic bactericide)

<Evaluation of Biofilm-Removing Effect>

The biofilm-removing effect and the biofilm formation-inhibiting effect of each of the substances to be evaluated shown in Table 1 were confirmed according to the evaluation methods specified in the present invention using each biofilm treatment agent containing each substance to be evaluated as a biofilm treatment agent component. The concentration at which each substance to be evaluated is added to a medium is shown in Table 2. In addition, evaluation results of the biofilm-removing effect and the biofilm formation-inhibiting effect of each aromatic monohydric alcohol alone are shown in

Table 3, and evaluation results of the biofilm-removing effect using a combination of substances to be evaluated are shown in Tables 4 to 6.

TABLE 2

| | Concentration |
|---|---|
| Substances to be evaluated | (ppm) |
| 1-Phenylmethanol | 1,000 |
| 1-Phenylethanol | 1,000 |
| 2-Phenylethanol | 1,000 |
| 2-Phenoxyethanol | 1,000 |
| 3-Phenoxy-1-propanol | 1,000 |
| Cinnamyl alcohol | 1,000 |
| 1-Pentanol | 1,000 |
| 2-Phenyl-1,3-propanediol | 1,000 |
| 3-Phenoxy-1,2-propanediol | 1,000 |
| Anthranylamide | 1,000 |
| Methyl anthranilate | 500 |
| Anthranilic acid | 1,000 |
| Rhamnolipid | 100 |
| Sophorolipid | 100 |
| Surfactin | 10 |
| SDS | 100 |
| LAS | 100 |
| POELE | 100 |
| DBNPA | 9.75 |

TABLE 3

| | | | Evaluation results | |
|---|---|---|---|---|
| | | | | Formation- |
| | | | | inhibiting |
| | Biofilm treatment agent components | | Removal | effect |
| | | Alcohols other than | effect | (formation |
| | A1: Aromatic | A1 components, | (removal | inhibition |
| | monohydric alcohols | or organic bactericide | rate %) | rate %) |
| Example 1 | 1-Phenylmethanol | | 45 | 47 |
| Example 2 | 1-Phenylethanol | | 42 | 43 |
| Example 3 | 2-Phenylethanol | | 41 | 48 |
| Example 4 | 2-Phenoxyethanol | | 44 | 56 |
| Example 5 | 3-Phenoxy-1-propanol | | 44 | 43 |
| Example 6 | Cinnamyl alcohol | | 52 | 72 |
| Comparative | | 1-Pentanol | 16 | 11 |
| Example 1 | | | | |
| Comparative | | 2-Phenyl-1,3-propanediol | 16 | 18 |
| Example 2 | | | | |
| Comparative | | 3-Phenoxy-1,2-propanediol | 10 | 13 |
| Example 3 | | | | |
| Comparative | | DBNPA | 14 | 2 |
| Example 4 | | | | |

TABLE 4

| | Biofilm treatment agent components | | | Evaluation results |
|---|---|---|---|---|
| | A2 | | Synthetic | Removal results |
| | Anthranilic acid analogs | Biosurfactants | surfactants | (removal rate %) |
| Example 7 | Anthranylamide | Rhamnolipid | | 41 |
| Example 8 | Anthranylamide | Surfactin | | 47 |
| Example 9 | Anthranylamide | Sophorolipid | | 55 |
| Example 10 | Methyl anthranilate | Rhamnolipid | | 58 |
| Example 11 | Methyl anthranilate | Surfactin | | 54 |
| Example 12 | Anthranilic acid | Rhamnolipid | | 43 |
| Example 13 | Anthranilic acid | Surfactin | | 45 |
| Comparative Example 5 | Anthranylamide | | | 25 |
| Comparative Example 6 | Methyl anthranilate | | | 33 |
| Comparative Example 7 | Anthranilic acid | | | 20 |
| Comparative Example 8 | | Rhamnolipid | | 24 |
| Comparative Example 9 | | Surfactin | | 24 |
| Comparative Example 10 | | Sophorolipid | | 36 |
| Comparative Example 11 | Anthranylamide | | SDS | 23 |
| Comparative Example 12 | Anthranylamide | | LAS | 14 |
| Comparative Example 13 | Anthranylamide | | POELE | 26 |

TABLE 5

| | Biofilm treatment agent components | | | Evaluation results |
|---|---|---|---|---|
| | A1 | A2 | | Removal results |
| | Aromatic monohydric alcohols | Anthranilic acid analogs | Biosurfactants | (removal rate %) |
| Example 14 | 1-Phenylethanol | Anthranylamide | Rhamnolipid | 67 |
| Example 15 | 1-Phenylethanol | Anthranylamide | Surfactin | 56 |
| Example 16 | 2-Phenylethanol | Anthranylamide | Rhamnolipid | 61 |
| Example 17 | Cinnamyl alcohol | Anthranylamide | Surfactin | 75 |
| Example 18 | Cinnamyl alcohol | Anthranylamide | Sophorolipid | 72 |
| Example 19 | 2-Phenoxyethanol | Anthranylamide | Rhamnolipid | 65 |
| Example 20 | 2-Phenoxyethanol | Anthranylamide | Surfactin | 66 |
| Example 21 | 2-Phenoxyethanol | Anthranylamide | Sophorolipid | 69 |
| Example 22 | 2-Phenoxyethanol | Methyl anthranilate | Sophorolipid | 78 |
| Example 23 | 2-Phenoxyethanol | Anthranilic acid | Rhamnolipid | 63 |
| Example 24 | 2-Phenoxyethanol | Anthranilic acid | Sophorolipid | 68 |

TABLE 6

| | Biofilm treatment agent components | | | | | |
|---|---|---|---|---|---|---|
| | | | | | Aromatic | |
| | | | | | monohydric | |
| | | | | | alcohol/ | |
| | | | | | Anthranilic | Evaluation |
| | | | | | acid analog/ | results |
| | A1 | | | | Biosurfactant/ | Removal |
| | Aromatic | A2 | | | Synthetic | results |
| | monohydric | Anthranilic | | Synthetic | surfactant (mass | (removal |
| | alcohols | acid analogs | Biosurfactants | surfactants | ratio) | rate %) |
| Example | 1-Phenylethanol | Anthranylamide | Sophorolipid | LAS | 1/1/0.1/0.1 | 76 |
| 25 | | | | | | |
| Example | 2-Phenoxyethanol | Anthranylamide | Rhamnolipid | SDS | 1/1/0.1/0.1 | 78 |
| 26 | | | | | | |
| Example | 2-Phenoxyethanol | Anthranylamide | Rhamnolipid | LAS | 1/1/0.1/0.1 | 72 |
| 27 | | | | | | |
| Example | 2-Phenoxyethanol | Anthranylamide | Rhamnolipid | POELE | 1/1/0.1/0.1 | 87 |
| 28 | | | | | | |
| Example | 2-Phenoxyethanol | Anthranylamide | Surfactin | SDS | 1/1/0.01/0.1 | 80 |
| 29 | | | | | | |
| Example | 2-Phenoxyethanol | Anthranylamide | Surfactin | LAS | 1/1/0.01/0.1 | 79 |
| 30 | | | | | | |
| Example | 2-Phenoxyethanol | Anthranylamide | Surfactin | POELE | 1/1/0.01/0.1 | 91 |
| 31 | | | | | | |
| Example | 2-Phenoxyethanol | Anthranylamide | Sophorolipid | SDS | 1/1/0.1/0.1 | 79 |
| 32 | | | | | | |
| Example | 2-Phenoxyethanol | Anthranylamide | Sophorolipid | POELE | 1/1/0.1/0.1 | 83 |
| 33 | | | | | | |
| Example | 2-Phenoxyethanol | Methyl anthranilate | Surfactin | POELE | 1/0.5/0.01/0.1 | 87 |
| 34 | | | | | | |
| Example | 2-Phenoxyethanol | Anthranilic acid | Surfactin | POELE | 1/1/0.01/0.1 | 77 |
| 35 | | | | | | |
| Example | Cinnamyl alcohol | Anthranylamide | Sophorolipid | SDS | 1/1/0.1/0.1 | 89 |
| 36 | | | | | | |

It can be seen from Tables 3 and 4 that biofilm treatment agents containing at least an A1 component or an A2 component specified in the present invention have an excellent biofilm-removing effect compared to biofilm treatment agents containing a compound other than the components specified in the present invention. In addition, it can be seen that the A1 components exhibit an excellent effect not only in the biofilm-removing effect but also in the biofilm formation-inhibiting effect compared to biofilm treatment agents containing a compound other than the components specified in the present invention.

It can be seen from Tables 5 and 6 that biofilm treatment agents containing at least both A1 and A2 components specified in the present invention have a superior removal effect than those containing an A1 component or an A2 component alone in comparison with Table 3 or 4. In addition, it can be seen from Tables 5 and 6 that biofilm treatment agents further containing at least a synthetic surfactant in addition to both A1 and A2 components specified in the present invention have a superior removal effect compared to a case where biofilm treatment agents contain no synthetic surfactant (for example, in comparison between Example 19 and Example 26).

### INDUSTRIAL APPLICABILITY

According to the present non, it is possible to provide a biofilm treatment agent effective for biofilm-forming bacteria using at least any one of an aromatic monohydric alcohol, an anthranilic acid analog, and a biosurfactant as an active component.

In particular, it is possible to provide a treatment agent effective for biofilms formed in routes which come into contact with water of a water separation membrane, a cooling tower, medical devices, and the like.

In addition, since the treatment agent of the present invention has a biofilm formation-inhibiting effect and a biofilm removal effect even at a neutral pH, it is safe because it is unnecessary to consider influences on the human body and water environment used.

1. A biofilm treatment agent comprising at least A1 and/or A2 below:
A1: an aromatic monohydric alcohol,
A2: an anthranilic acid analog and a biosurfactant.

2. A biofilm treatment agent comprising at least an aromatic monohydric alcohol, an anthranilic acid analog, a biosurfactant, and a synthetic surfactant.

3. The biofilm treatment agent according to claim 1,
wherein the aromatic monohydric alcohol is a compound represented by Formula (1) or (2) below or cinnamyl alcohol: 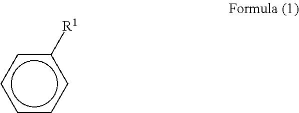
R¹: a linear alkyl group having 1 to 3 carbon atoms in which one arbitrary hydrogen atom is substituted with a hydroxyl group, 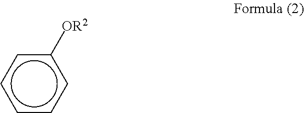
R²: a linear alkyl group having 1 to 3 carbon atoms in which one arbitrary hydrogen atom is substituted with a hydroxyl group.

4. The biofilm treatment agent according to claim 1,
wherein the anthranilic acid analog is at least one selected from anthranilic acid, methyl anthranilate, ethyl anthranilate, anthranylamide, and salts thereof.

5. The biofilm treatment agent according to claim 1,
wherein the biosurfactant is an amino acid-type or glycolipid-type biosurfactant.

6. The biofilm treatment agent according to claim 2,
wherein the synthetic surfactant is at least one selected from sodium dodecyl sulfate, sodium dodecylbenzene sulfonate, and polyoxyethylene lauryl ether.

7. The biofilm treatment agent according to claim 2 containing an aromatic monohydric alcohol, an anthranilic acid analog, a biosurfactant, and a synthetic surfactant at a mass ratio of 1/0.25 to 2/0.0005 to 2/0.005 to 2.

8. The biofilm treatment agent according to claim 1,
wherein a biofilm is formed from bacteria containing at least gram-negative bacteria.

9. A biofilm treatment method in which the biofilm treatment agent according to claim 1 is used, the method comprising:
using the biofilm treatment agent within a concentration range of less than the minimum inhibitory concentration.

10. The biofilm treatment agent according to claim 2,
wherein the aromatic monohydric alcohol is a compound represented by Formula (1) or (2) below or cinnamyl alcohol: 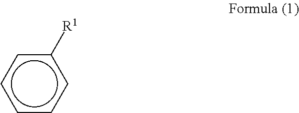
R¹: a linear alkyl group having 1 to 3 carbon atoms in which one arbitrary hydrogen atom is substituted with a hydroxyl group, 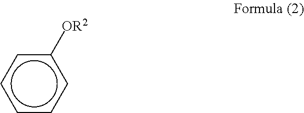
R²: a linear alkyl group having 1 to 3 carbon atoms in which one arbitrary hydrogen atom is substituted with a hydroxyl group.

11. The biofilm treatment agent according to claim 2,
wherein the anthranilic acid analog is at least one selected from anthranilic acid, methyl anthranilate, ethyl anthranilate, anthranylamide, and salts thereof.

12. The biofilm treatment agent according to claim 2,
wherein the biosurfactant is an amino acid-type or glycolipid-type biosurfactant.

13. The biofilm treatment agent according to claim 2,
wherein a biofilm is formed from bacteria containing at least gram-negative bacteria.

14. The biofilm treatment agent according to claim 3,
wherein a biofilm is formed from bacteria containing at least gram-negative bacteria.

15. The biofilm treatment agent according to claim 4,
wherein a biofilm is formed from bacteria containing at least gram-negative bacteria.

16. The biofilm treatment agent according to claim 5,
wherein a biofilm is formed from bacteria containing at least gram-negative bacteria.

17. The biofilm treatment agent according to claim 6,
wherein a biofilm is formed from bacteria containing at least gram-negative bacteria.

18. The biofilm treatment agent according to claim 7,
wherein a biofilm is formed from bacteria containing at least gram-negative bacteria.

19. A biofilm treatment method in which the biofilm treatment agent according to claim 2 is used, the method comprising:
using the biofilm treatment agent within a concentration range of less than the minimum inhibitory concentration.
